(19) United States
(12) Patent Application Publication
(10) Pub. No.: US 2007/0105077 A1
(43) Pub. Date: May 10, 2007

(54) Worksheet for solving number logic based placement puzzles

(76) Inventor: Edward A. Pechter, Valencia, CA (US)

Correspondence Address: Matthew F. Jodziewicz, Esq., 3447 Mandeville Canyon Road, Los Angeles, CA, 90049, US

(21) Appl. No.: 11/270,369

(22) Filed: Nov. 10, 2005

(51) Int. Cl. G09B 19/02

(52) U.S. Cl. 434/188

(57) ABSTRACT

A worksheet and a method for using a worksheet having a 9×9 grid of playing cells where each of the playing cells contains a 3×3 subgrid of possible answer cells printed therein where the 9 possible answer cells contain the numbers 1 through 9, respectively, that is useful for solving Sudoku number logic-placement puzzles.

Number logic-based placement puzzles have been popular for many years. Recently, the number logic puzzle known by the Japanese name of Sudoku ( [symbol] , s u̅doku), sometimes spelled Su Doku, has achieved a large following, appearing in many newspapers and magazines worldwide. The aim of the puzzle is to enter a number, usually from 1 through 9, in each cell of a grid, most frequently a 9×9 grid made up of 3×3 sub grids (called “regions”), starting with various numerals given in some cells (the “givens”). Each row, column and region must contain only one instance of each numeral. Completing the puzzle requires patience and logical ability. Its grid layout is reminiscent of other newspaper puzzles like crosswords and board games such as chess.

### BACKGROUND OF THE INVENTION

The word Sudoku means “numbers singly” in Japanese. (This name is a registered trademark of puzzle publisher Nikoli Co. Ltd in Japan, and other Japanese publishers generally refer to it as “number place”. The numerals in Sudoku puzzles are used for convenience. The arithmetic relationships between numerals are absolutely irrelevant to the solution of the puzzle. Any set of distinct finite symbols will do; letters, shapes, or colors may be used without altering the rules. The puzzle's originator has been using numerals for Number Place in its magazines since they first published it over 25 years ago and such non-numerical symbols are also considered to be within the scope of this invention. However, for ease of description and understanding, numerals are used throughout the description of the invention given below.

The attraction of the puzzle is that while the completion rules are simple, the line of reasoning required to reach a successful completion may be difficult. Some educators have recommended Sudoku as a useful exercise in logical reasoning for their students. The level of difficulty of the puzzles can be selected to suit the audience. The puzzles are often available free from published sources and also may be custom-generated using software.

The puzzle is most frequently a 9×9 grid made up of 3×3 sub grids (called “regions”). Some cells already contain numbers, known as “givens”. The goal is to fill in the empty cells, one number in each, so that each column, row, and region contains the numbers 1-9 exactly once. Each number in the solution therefore occurs only once in each of three “directions”, hence the “single numbers” implied by the puzzle's name.

The strategy for solving a puzzle may be regarded as comprising a combination of three processes: scanning, marking up, and analyzing.

Scanning

Scanning is performed at the outset of beginning the solution process and periodically throughout the solution process. Scans may have to be performed several times in between analysis periods. Two basic techniques comprise scanning:
Cross-hatching: the scanning of rows (or columns) to identify which line in a particular region may contain a certain number by a process of elimination. This process is then repeated with the columns (or rows). For fastest results, the numbers are scanned in order of their frequency. It is important to perform this process systematically, checking all of the digits 1-9.
Counting 1-9 in regions, rows, and columns to identify missing numbers. Counting based upon the last number discovered may speed up the search. It also can be the case (typically in tougher puzzles) that the value of an individual cell can be determined by counting in reverse—that is, scanning its region, row, and column for values it cannot be to see which is left.

Some solvers look for“contingencies” while scanning—that is, narrowing a number's location within a row, column, or region to two or three cells. When those cells all lie within the same row (or column) and region, they can be used for elimination purposes during cross-hatching and counting. Particularly challenging puzzles may require multiple contingencies to be recognized, perhaps in multiple directions or even intersecting—relegating most solvers to marking up (as described below). Puzzles which can be solved by scanning alone without requiring the detection of contingencies are classified as “easy” puzzles; more difficult puzzles, by definition, cannot be solved by basic scanning alone.

Marking up

Scanning for potential numbers comes to a halt when no further numbers can be readily discovered. From this point in the solution process, it is necessary to engage in some logical analysis. Many find it useful to guide this analysis by marking candidate numbers in the blank cells. There are two popular notations: subscripts and dots.
In the subscript notation the candidate numbers are written in subscript in the cells. The drawback to this is that original puzzles printed in a newspaper usually are too small to accommodate more than a few digits of normal handwriting. If using the subscript notation, solvers often create a larger copy of the puzzle or employ a sharp or mechanical pencil. However, even with such sharpened writing pencils, the puzzle grid soon becomes both more confusing and difficult to work on with each passing erasure, leading to greater difficulty in continuing the solving process.
The second notation is a pattern of dots with a dot in the top left hand corner representing a 1 and a dot in the bottom right hand corner representing a 9. The dot notation has the advantage that it can be used on the original puzzle. Dexterity is required in placing the dots, since misplaced dots or inadvertent marks inevitably lead to confusion and may not be easy to erase without adding to the confusion. Using a pencil would then be recommended.
   Analyzing

Two main analysis approaches are“elimination” and “what-if”.
In elimination, progress is made by successively eliminating candidate numbers from one or more cells to leave just one choice. After each answer has been achieved, another scan may be performed—usually checking to see the effect of the latest number. There are a number of elimination tactics, all of which are based on the simple rules given above, which have important and useful corollaries, including:

1. A given set of n cells in any particular block, row, or column can only accommodate n different numbers. This is the basis for the “unmatched candidate deletion” technique, discussed below.

2. Each set of candidate numbers, 1-9, must ultimately be in an independently self-consistent pattern. This is the basis for advanced analysis techniques that require inspection of the entire set of possibilities for a given candidate number. Only certain “closed circuit” or “n×n grid” possibilities exist (which have acquired peculiar names such as “X-wing” and “Swordfish”, among others). If these patterns can be identified, elimination of candidate possibilities external to the grid framework can sometimes be achieved.
One of the most common elimination tactics is “unmatched candidate deletion”. Cells with identical sets of candidate numbers are said to be matched if the quantity of candidate numbers in each is equal to the number of cells containing them. For example, cells are said to be matched within a particular row, column, or region (scope) if two cells contain the same pair of candidate numbers (p,q) and no others, or if three cells contain the same triplet of candidate numbers (p,q,r) and no others. These are essential coincident contingencies: the placement of these numbers anywhere else in the matching scope would make a solution for the matched cells impossible. Thus, the candidate numbers (p,q,r) appearing in unmatched cells in the row, column or region scope can be deleted. This principle also works with candidate number subsets—if three cells only have candidates (p,q,r), (p,q) and (q,r), or even (p,r), (q,r) and (p,q), all of the set (p,q,r) elsewhere in the scope can be deleted. The principle is true for all quantities of candidate numbers.

A second related principle is also true—if the number of cells (in a row, column or region scope) where a set of candidate numbers only appear is equal to the quantity of candidate numbers, the cells and numbers are matched and only those numbers can appear in matched cells. Other candidates in the matched cells can be eliminated. For example, if (p,q) can only appear in 2 cells (within a specific row, column, region scope), other candidates in the 2 cells can be eliminated. The first principle is based on cells where only matched numbers appear. The second is based on numbers that appear only in matched cells. Advanced techniques carry these concepts further to include multiple rows, columns, and blocks. (See“X-wing” and “Swordfish”, above.)
In the what-if approach, a cell with only two candidate numbers is selected, and a guess is made. The steps above are repeated unless a duplication is found or a cell is left with no possible candidate, in which case the alternative candidate is the solution. In logical terms, this is known as reductio ad absurdum. Nishio is a limited form of this approach: for each candidate for a cell, the question is posed: will entering a particular number prevent completion of the other placements of that number? If the answer is yes, then that candidate can be eliminated. The what-if approach requires a pencil and eraser. This approach may be frowned on by logical purists as trial and error (and most published puzzles are built to ensure that it will never be necessary to resort to this tactic,) but it can arrive at solutions fairly rapidly.

Ideally one needs to find a combination of techniques which avoids some of the drawbacks of the above elements. The counting of regions, rows, and columns can feel boring. Writing candidate numbers into empty cells can be time-consuming. The what-if approach can be confusing unless you are well organized. The present invention provides a technique which minimizes counting, marking up, and rubbing out.

### DESCRIPTION OF THE DRAWINGS

FIG. 1 is an illustration of the basic puzzle grid as it would appear in a worksheet embodying the present invention;

FIG. 2 is a puzzle grid as it would appear in, say a newspaper or magazine for solution with “given” numbers entered into the grid;

FIG. 3 is a puzzle grid embodying the present invention as it would appear when the “given” numbers have been crossed off from the playing cell subgrids; and,

FIG. 4 is the puzzle grid of FIG. 3 illustrating a solved puzzle.

### DESCRIPTION OF THE PREFERRED EMBODIMENT OF THE INVENTION

A preferred embodiment of the present invention will now be described with reference to the Figures which show a worksheet constructed in accordance with the present invention that is useful for solving Sudoku number logic-placement puzzles.

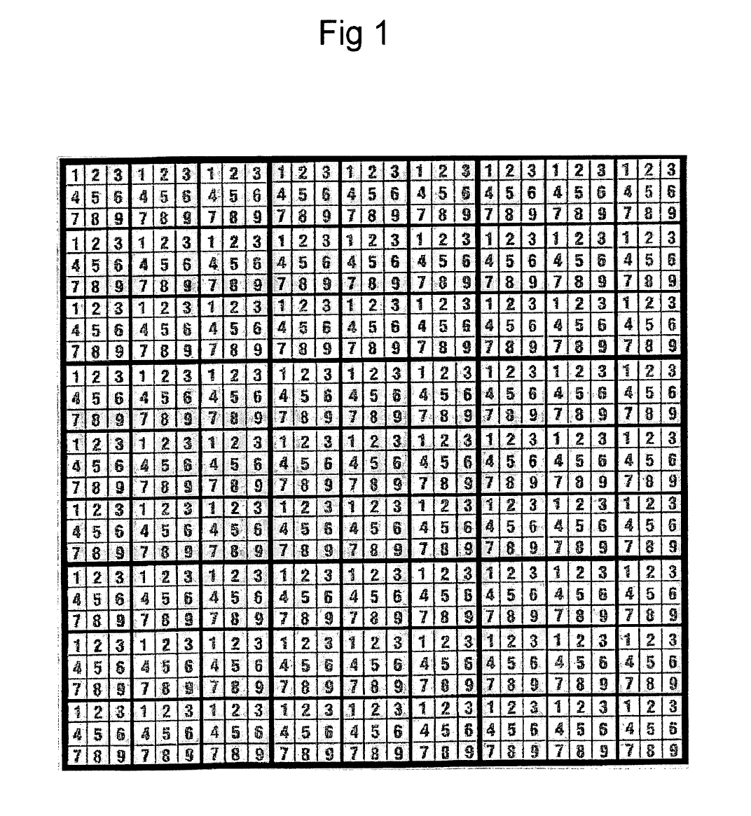

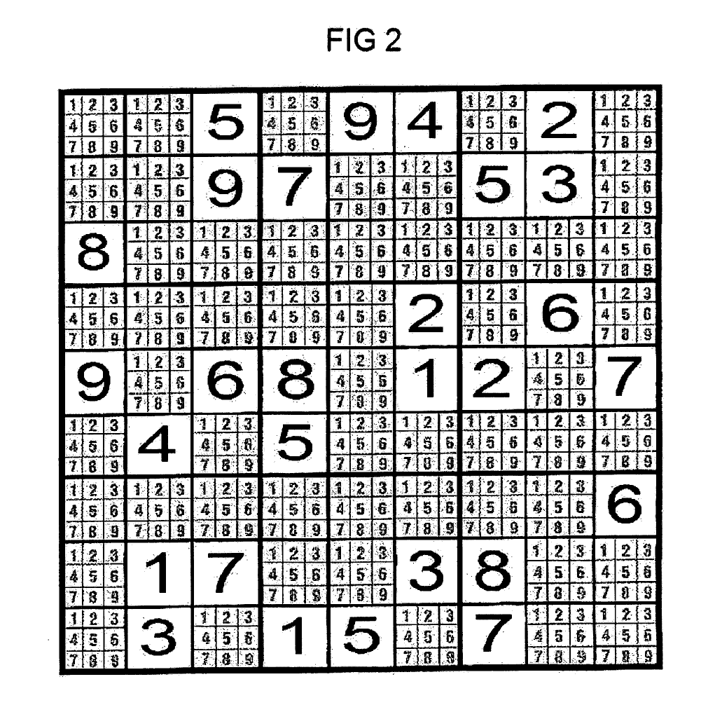

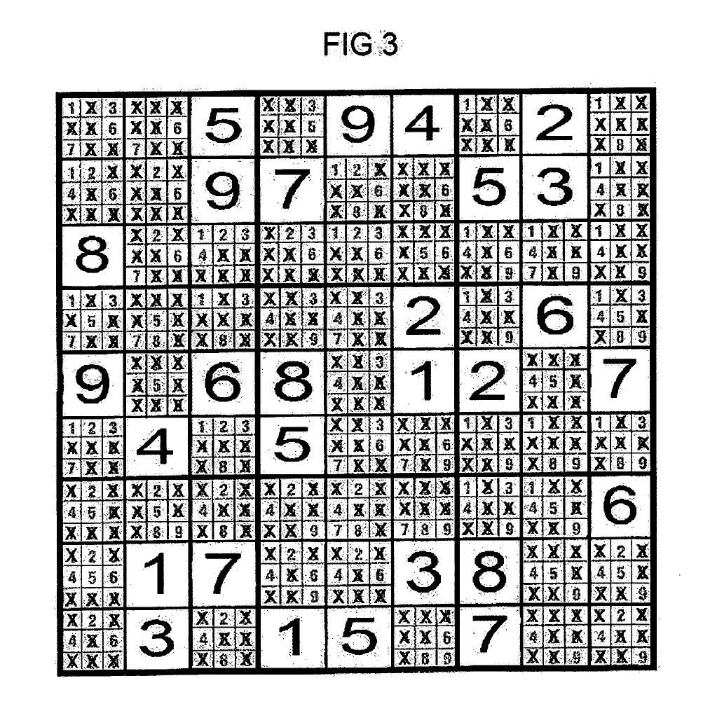

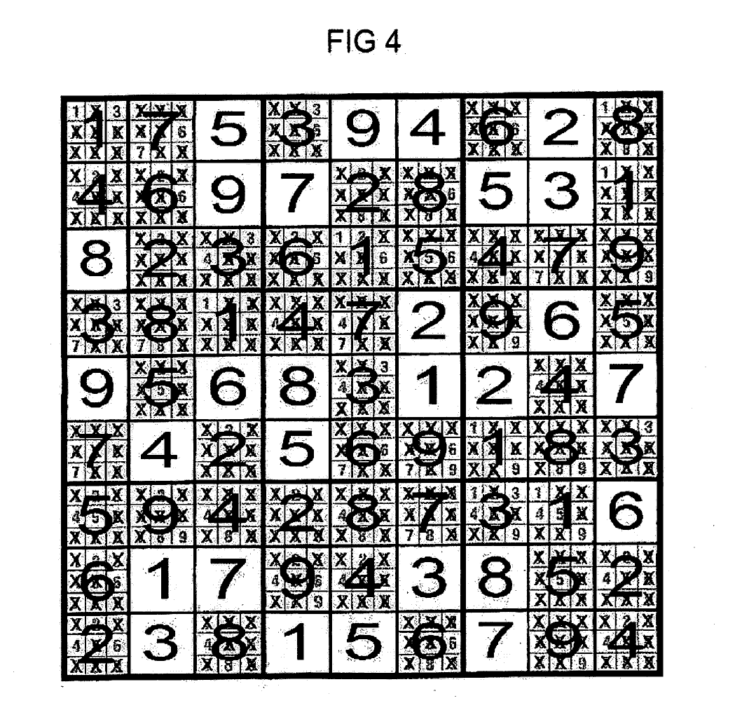

The puzzle grid as shown in FIGS. 1 to 4, is most frequently a 9×9 grid made up of 3×3 sub grids (called “regions”) outlined by darker borders for ease in recognition. Some cells already contain numbers, known as “givens” which are the larger numbers shown in FIGS. 2 and 4 occupying the entire playing cell. The goal is to fill in the empty cells, one number in each, so that each column, row, and region contains the numbers 1-9 exactly once. Each number in the solution therefore occurs only once in each of three “directions”, hence the “single numbers” implied by the puzzle's name.

Initially, as shown in FIG. 1, the worksheet has printed in each playing cell not containing an initial given number, a 3×3 sub grid of possible answer cells. Each of the answer cells in the playing cell contains one of the numbers 1 through 9, respectively, thus representing the possible number choices for each of the playing cells.

Preferably the subgrid of possible answer cells and included numbers are of a lighter or distinguishable type or color than that of the given numbers or grid and region borders to assist the solver in analyzing various potential numbers as answers.

A method of solving Sudoku number logic-placement puzzles appearing in a 9×9 grid of playing cells having superimposed thereon by outlining in a distinctive border a 3×3 subgrid of regions each containing 9 playing cells each, which embodies the present invention is illustrated in FIGS. 1 through 4 and includes the steps of:

Creating a worksheet having in each of the playing cells a 3×3 subgrid of possible answer cells where the 9 possible answer cells contain the numbers 1 through 9, respectively as is shown in FIG. 1. This is the initial stage of the solution process.

As shown in FIG. 2, the solver then uses the given initial numbers to cross off those subgrid answer cells for each playing cell in a row and column which contains a number not logically possible for that playing cell.

The solver then continues to cross off those remaining subgrid answer cells for each playing cell in a row and column which contains a number not logically possible for that playing cell as correct playing cell number entries are derived.

FIG. 4 illustrates the appearance of a worksheet embodying the present invention as it would appear with the puzzle solved having all non possible subgrid answer cells crossed off and correct playing cell number entries marked in large print.

While only a certain preferred embodiment of this invention has been described, it is understood that many variations are possible without departing from the principles of this invention as defined by the claims which follow.

What is claimed is:

1. A worksheet useful for solving Sudoku number logic puzzles appearing in a 9×9 grid of playing cells having superimposed thereon by outlining in a distinctive border a 3×3 subgrid of regions each containing 9 playing cells each, the worksheet comprising:
A 9×9 grid of playing cells wherein each of said playing cells contains a 3×3 subgrid of possible answer cells printed therein where said 9 possible answer cells contain the numbers 1 through 9, respectively.

2. A worksheet as in claim 1 wherein said 3×3 subgrid of possible answer cells are printed in a different color than that color used to define the 9×9 grid of playing cells.

3. A worksheet as in claim 1 wherein said 3×3 subgrid of possible answer cells are printed in a lighter shade of color than that shade of color used to define the 9×9 grid of playing cells.

4. A worksheet as in claim 1 wherein said numbers 1 through 9 appearing in said possible answer cells are printed in a different color than that color used to define the 9×9 grid of playing cells.

5. A worksheet as in claim 1 wherein said numbers 1 through 9 appearing in said possible answer cells are printed in a lighter shade of color than that shade of color used to define the 9×9 grid of playing cells.

6. A worksheet useful for solving Sudoku number logic puzzles appearing in a 9×9 grid of playing cells having superimposed thereon by outlining in a distinctive border a 3×3 subgrid of regions each containing 9 playing cells each, the worksheet comprising:
A 9×9 grid of playing cells wherein each of said playing cells not containing an initial given number, contains a 3×3 subgrid of possible answer cells printed therein where said 9 possible answer cells contain the numbers 1 through 9, respectively.

7. A worksheet as in claim 6 wherein said 3×3 subgrid of possible answer cells are printed in a different color than that color used to define the 9×9 grid of playing cells.

8. A worksheet as in claim 6 wherein said 3×3 subgrid of possible answer cells are printed in a lighter shade of color than that shade of color used to define the 9×9 grid of playing cells.

9. A worksheet as in claim 6 wherein said numbers 1 through 9 appearing in said possible answer cells are printed in a different color than that color used to define the 9×9 grid of playing cells.

10. A worksheet as in claim 6 wherein said numbers 1 through 9 appearing in said possible answer cells are printed in a lighter shade of color than that shade of color used to define the 9×9 grid of playing cells.

11. A method of solving Sudoku number logic puzzles appearing in a 9×9 grid of playing cells having superimposed thereon by outlining in a distinctive border a 3×3 subgrid of regions each containing 9 playing cells each, the method comprising the steps of:
Creating a worksheet having in each of the playing cells a 3×3 subgrid of possible answer cells where the 9 possible answer cells contain the numbers 1 trough 9, respectively;
Crossing off each possible answer cell in each playing cell 3×3 subgrid which contains a number not logically possible for that playing cell in a successful solution of the 9×9 grid of playing cells.
